(19) United States
(12) Patent Application Publication
(10) Pub. No.: US 2010/0156754 A1
(43) Pub. Date: Jun. 24, 2010

(54) Dielectric loaded antenna having hollow portion therein

(75) Inventor: Asahi Kondou, Kariya-shi (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/653,185

(22) Filed: Dec. 9, 2009

(30) Foreign Application Priority Data
Dec. 11, 2008 (JP) 2008-315603

(51) Int. Cl. H01Q 15/08

(52) U.S. Cl. 343/911 R

(57) ABSTRACT

A dielectric block disposed on a substrate so as to cover a radiation patch formed on the substrate has a cylindrical outer shape. A concave portion is provided in a bottom surface (referred to as an opposing bottom surface) of the dielectric block on the side attached to the substrate. Directivity of a dielectric loaded antenna is adjusted by the size of a hollow section formed by the concave portion being adjusted. As a result, desired directivity in a desired frequency band can be actualized without an outer size of the dielectric block (and, thus, an antenna opening size) being changed. In addition, a material (dielectric constant) of the dielectric block can be arbitrarily selected, regardless of the outer shape (size) of the dielectric block. Therefore, freedom of design can be enhanced.

### CROSS-REFERENCE TO RELATED APPLICATION

This application is based on and claims the benefit of priority from earlier Japanese Patent Application No. 2008-315603 filed Dec. 11, 2008, the description of which is incorporated herein by reference.

### BACKGROUND OF THE INVENTION

1. Field of the Invention

The present invention relates to a dielectric loaded antenna used for transmitting/receiving radio wave having microwave or millimeter-wave bands.

2. Description of the Related Art

Conventionally, a dielectric loaded antenna is known of which antenna gain is enhanced by using a dielectric material. The dielectric material is formed into a cylinder that covers a radio wave radiation source configured by a microstrip line, a waveguide and the like (the dielectric material is hereinafter referred to as a “dielectric block”).

For example, a dielectric loaded antenna is disclosed in Japanese Patent Laid-open Publication No. 2005-130464. In the dielectric loaded antenna, the outer shape of the dielectric block is modified to increase the angular range over which high gain can be achieved (i.e., width of a main lobe). Specifically, as shown in FIG. 1, of the bottom surfaces of a cylindrical dielectric block, a concave portion is formed on the bottom surface (opened bottom surface) on a side opposite to the bottom surface (opposing bottom surface) facing the radiation source.

In other words, the outer shape is modified such that a path difference occurs depending on the portion of the dielectric block through which radio waves enter from the opposing bottom surface of the dielectric block pass. As a result of the radio waves radiated from the opened bottom surface and side surface of the dielectric block having phase difference depending on the path difference, directivity is controlled.

However, in the technique described in Japanese Patent Laid-open Publication No. 2005-130464, directivity of the antenna (width of the main lobe and antenna opening size), frequency range, and dielectric constant of the dielectric block all affect the outer shape of the dielectric block. Therefore, if the size (outer shape) of the dielectric block is restricted by the size of the mounting space and the like, a problem occurs in that it is difficult to design the dielectric loaded antenna so as to achieve desired directivity.

In other words, because the outer shape of the dielectric block varies depending on usage conditions (directivity to be obtained and frequency to be used) and materials to be used (dielectric constant of the dielectric block), a problem occurs in that standardization is difficult.

### SUMMARY OF THE INVENTION

The present invention has been achieved to solve the above-described issues. An object of the present invention is to provide a dielectric loaded antenna that can obtain the desired directivity without changing an outer shape of the dielectric block.

To achieve the above-described object, a dielectric loaded antenna of the present invention includes a radiation source that radiates radio waves, and a dielectric block disposed so as to cover a radiation surface of the radiation source.

The dielectric block has a cylindrical outer shape. An opposing bottom surface that is one bottom surface is disposed facing the radiation surface of the radiation source. A concave portion used to adjust phase of radio waves radiated via the dielectric block is formed in the opposing bottom surface.

In the dielectric loaded antenna of the present invention configured as described above, the radio waves radiated from the radiation surface of the radiation source are radiated outside via a space formed by the concave portion and the dielectric block.

When the path length of the radio waves from the radiation source to an outer surface of the dielectric block is R, the path length in the space formed by the concave portion is R1 and the path length within the dielectric block is R2, the path length of the radio waves is R=R1+R2 (see FIG. 9).

Wavelength is shortened within the dielectric block depending on the dielectric constant of the dielectric block. Therefore, even when the outer shape of the dielectric block is constant and the path length R (=R1+R2) of the radio waves is constant, the phase of the radio waves radiated from each portion of the dielectric block and, thus, the directivity of the dielectric loaded antenna can be arbitrarily adjusted by a ratio of R1 and R2 being adjusted accordingly by adjustment of the shape of the concave portion.

Therefore, in the dielectric loaded antenna of the present invention, the antennal directivity can be adjusted without the outer shape of the dielectric block (and, thus, the antenna opening size) being changed. As a result, desired directivity in the desired frequency band can be easily obtained.

In the dielectric loaded antenna of the present invention, the material (dielectric constant) of the dielectric block can be arbitrarily selected regardless of the outer shape (size) of the dielectric block. Therefore, freedom of design can be enhanced.

The concave portion can be formed into a shape in which phases of radio waves radiated via the dielectric block match on a plane (plane P in FIG. 9) that comes into contact with the dielectric block on an opened bottom surface that is a bottom surface of the dielectric block differing from the opposing bottom surface, the plane p being perpendicular to an axial direction of the dielectric block. In this instance, the beam width of the main lobe can be narrowed.

The concave portion is preferably formed such that the dielectric block and the radiation surface of the radiation source are not in contact. In this instance, frequency characteristics of the radiation source are not affected by the dielectric constant of the dielectric block. Therefore, design of the radiation source can be facilitated.

Next, the outer shape of the dielectric block is preferably cylindrical or elliptical-cylindrical.

Particularly when the outer shape of the dielectric block is a cylinder, the width of the main lobe can be made uniform in any radial direction of the circular cross-section of the cylinder.

On the other hand, when the outer shape of the dielectric block is an elliptical cylinder, the width of the main lobe can be made to differ in the major axial and minor axial directions of the elliptical cross-section of the elliptical cylinder. Specifically, a flat beam shape that is narrow in the major diameter direction and wide in the minor diameter direction can be obtained.

### BRIEF DESCRIPTION OF THE DRAWINGS

FIG. 1 is a perspective view of a shape showing a dielectric block in a conventional apparatus;

FIG. 2A is an overall view showing a configuration of a dielectric loaded antenna according to a first embodiment.

FIG. 2B is a top view showing the dielectric loaded antenna of the FIG. 2A.

FIG. 3 is a cross-sectional view showing the dielectric loaded antenna according to the first embodiment;

FIG. 4A to FIG. 4C are graphs showing simulation results regarding directivity;

FIG. 5A and FIG. 5B are graphs showing simulation results regarding reflection characteristics and the like;

FIG. 6A is an exploded perspective view showing a configuration of a dielectric loaded antenna according to a second embodiment;

FIG. 6B is a top view showing the dielectric antenna of the FIG. 6A.

FIG. 7A and FIG. 7B are, respectively, an XZ cross-sectional view and an YZ cross-sectional view of the dielectric loaded antenna according to the second embodiment;

FIG. 8A and FIG. 8B are graphs showing simulation results regarding directivity; and

FIG. 9 is an explanatory diagram of a principle under which a phase of radio waves can be adjusted by a shape of a concave portion.

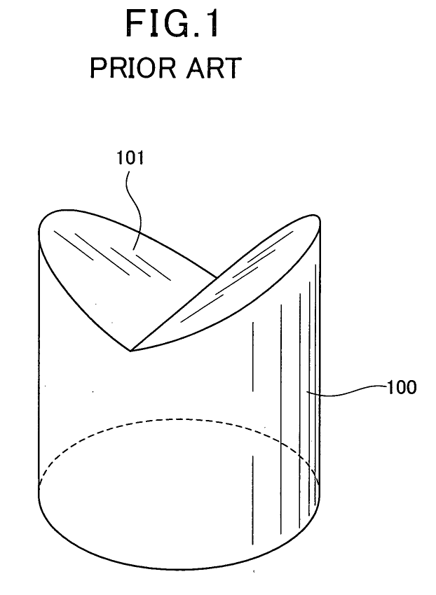

### DETAILED DESCRIPTION OF THE PREFERRED EMBODIMENTS

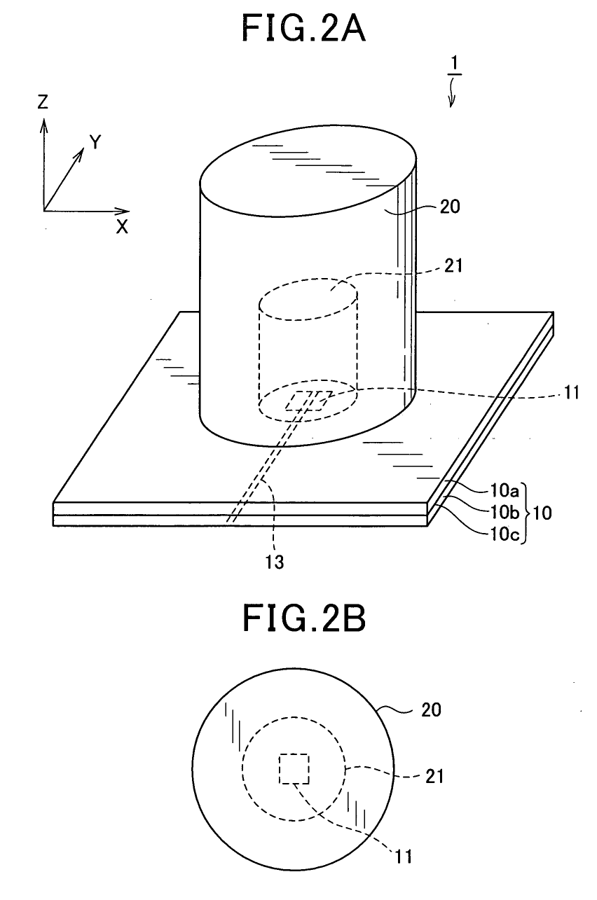

A dielectric loaded antenna according to the preferred embodiments of the present invention will be described with reference to FIG. 2 to FIG. 9.

### First Embodiment

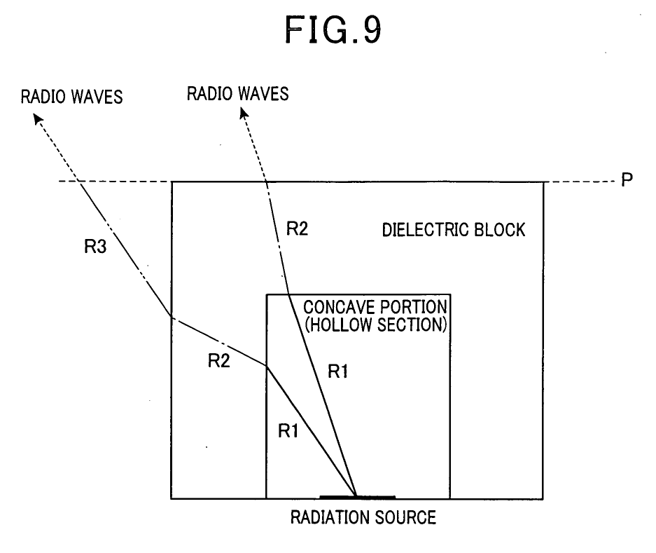

A first embodiment will be described with reference to FIG. 2 to FIG. 5, and FIG. 9.

FIG. 2A to FIG. 2B are an overall view showing a configuration of a dielectric loaded antenna 1 according to the first embodiment of the present invention.

As shown in FIG. 2A to FIG. 2B, the dielectric loaded antenna 1 includes a substrate 10 configuring a patch antenna and a dielectric block 20 disposed on the substrate 10 such as to cover a radio wave radiating area of the substrate 10.

The substrate 10 includes a pair of dielectric layers 10a and 10b that are stacked with a ground conductor 10c therebetween. A radiation patch 11 serving as a radio wave radiating area is formed on the surface of one dielectric layer 10a. A power supply line 13 that supplies power to the radiation patch 11 is formed on the surface of the other dielectric layer.

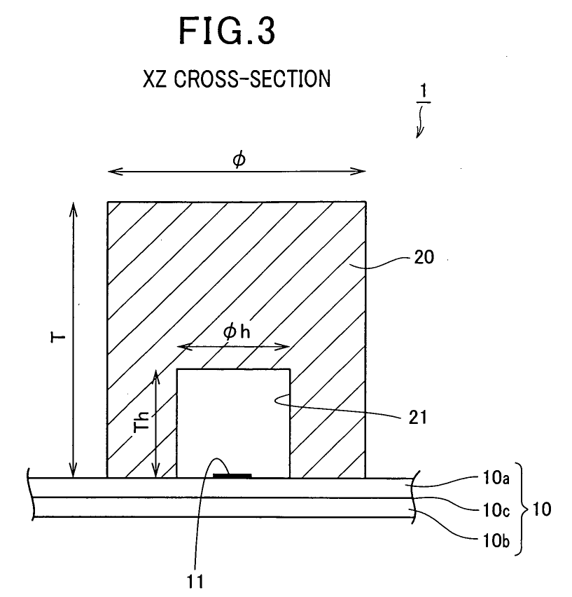

FIG. 3 is a cross-sectional view of the dielectric loaded antenna 1 taken along an XZ plane passing through the center of the dielectric block 20 in FIG. 2.

As shown in FIG. 2 and FIG. 3, the outer shape of the dielectric block 20 is formed into a cylinder. The circular bottom surface of the dielectric block 20 is formed to be of a size covering the entire radiation patch 11. Hereinafter, of the pair of bottom surfaces of the cylindrical dielectric block 20, the bottom surface on the side attached to the substrate 10 is referred to as an opposing bottom surface. The bottom surface on the other side is referred to as an opened bottom surface.

A concave portion 21 forming a hollow section with the substrate 10 when the dielectric block 20 is attached to the substrate 10 is formed in the opposing bottom surface of the dielectric block 20.

The concave portion 21 is shaped such that a cylindrical section concentric with the dielectric block 20 is carved out of the dielectric block 20. An inner diameter of the concave portion 21 is at least of a size preventing the radiation patch 11 disposed within the hollow section from coming into contact with the dielectric block 20.

The outer size (height T and diameter ø) of the dielectric block 20 and the size of the hollow section formed by the concave portion 21 (height Th and diameter [inner diameter] øh) are set such that desired directivity can be achieved depending on a dielectric constant εr of the dielectric block 20.

A design procedure of the dielectric block 20 will be described as below.

(A) Based on a frequency band f to be used (free-space wavelength λ) and a directivity half-power angle θh to be actualized (width of main lobe), an antenna opening size L is set using the relationship shown in equation (1). The outer size of the dielectric block 20 (height T and diameter ø) is then set using the relationship shown in equation (2).

θh=0.886×λ/L (1)

L²≈T²+ø² (2)

where, T and ø are set accordingly to satisfy the above-described relationship, based on mounting space and the like.

(B) A material (dielectric constant) of the dielectric block 20 is selected.

(C) The outer size defined by T and ø of the dielectric block 20 is fixed. The size Th and øh of the hollow section formed by the concave portion 21 of the dielectric block 20 is adjusted such that the phases of the radio waves radiated from each portion of the dielectric block 20 match on a plane (see plane P in FIG. 9) that comes into contact with the dielectric block 20 at the opened bottom surface side of the dielectric block 20, this plane being perpendicular to the axial direction of the dielectric block 20.

As shown in FIG. 9, the phases of the radio waves radiated from the dielectric block 20 on the plane P are determined by R1 (path length in the hollow section) and R2 (path length within the dielectric block), regarding the radio waves radiated from the opened bottom surface. The phases are determined by R1, R2, and R3 (path length from the side surface of the dielectric block 20 to the plane P), regarding the radio waves radiated from the side surface.

However, when making the adjustment, specifically, the directivity of the dielectric-loaded antenna 1 is determined while changing the size Th and øh of the hollow section accordingly, by a simulation being performed each time the size Th and øh is changed. A value obtained when an intensity difference between the main lobe and the side lobe is sufficiently large is used as an adjustment value.

### <Test>

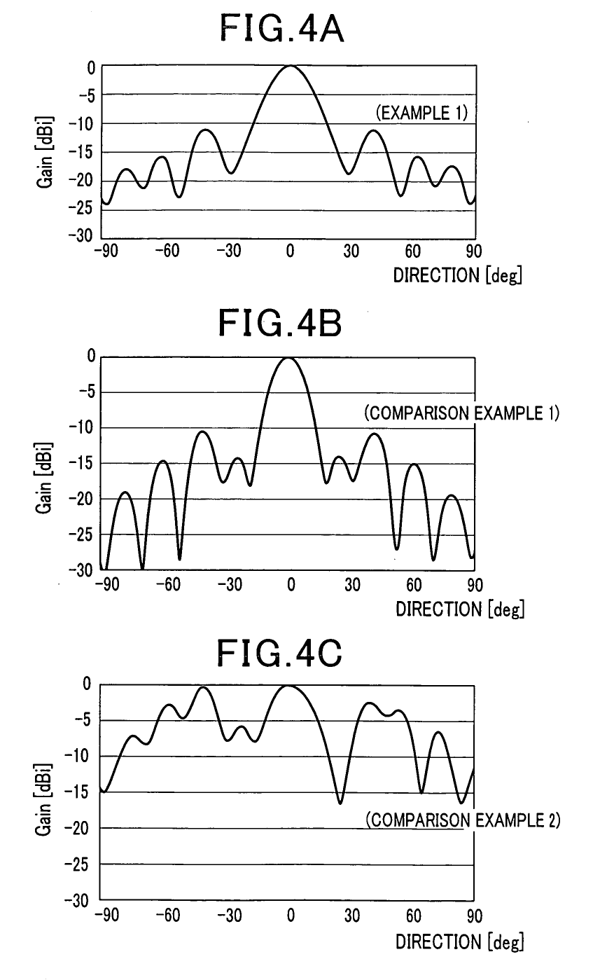

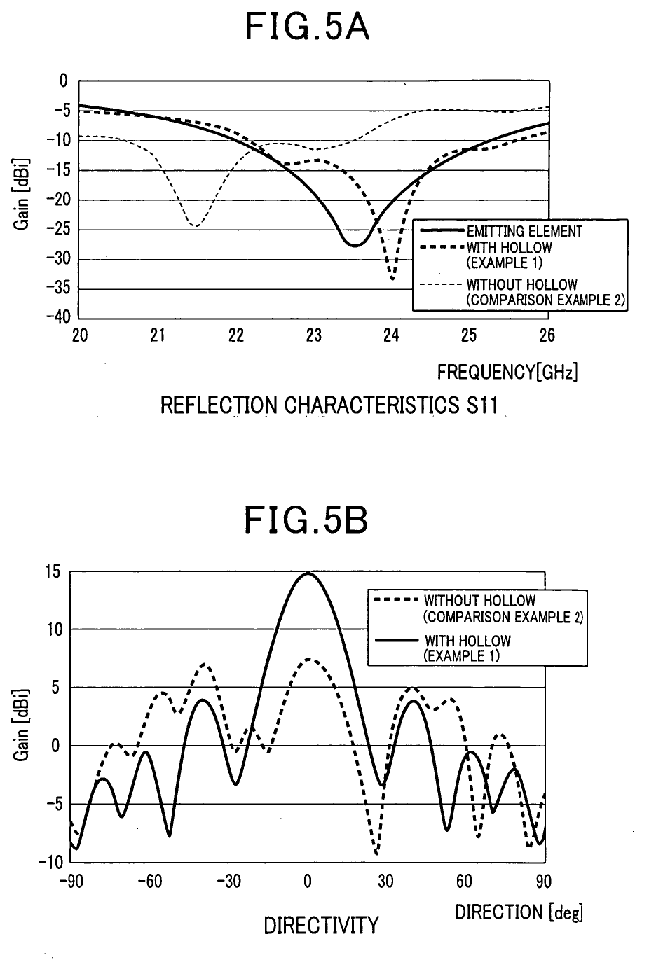

FIG. 4A to FIG. 4C, and FIG. 5A and FIG. 5B show simulation results obtained by an electromagnetic field analysis simulator.

FIG. 4A shows results of the dielectric loaded antenna 1 of the present invention (referred to, hereinafter, as “Example 1”) in which directivity is adjusted by the concave portion 21 of the dielectric block 20. FIG. 4B and FIG. 4C show results of simple cylindrical dielectric loaded antennas that do not have a concave portion 21 (referred to, hereinafter, as “Comparison Example 1” and “Comparison Example 2”).

The outer size of the dielectric block is T=36 mm and ø=31.8 mm. The dielectric constant εr of the dielectric block is 4.1 in the Example 1 and the Comparison Example 2, and 2.3 in the Comparison Example 1. The size of the hollow section of the dielectric block is Th=10.9 mm and θh=12 mm (only in the Example 1).

FIG. 5A is a graph showing reflection characteristics of the antenna. A solid line indicates a state in which the dielectric block is not attached. A thick dotted line indicates the Example 1. A thin dotted line indicates the Comparison Example 2. FIG. 5B is a diagram in which graphs indicating directivity of the Example 1 and directivity of the Comparison Example 2 are superimposed. A solid line indicates the Example 1. A dotted line indicates the Comparison Example 2.

When the frequency to be used is 24 GHz, the outer size of the dielectric block is T=36 mm and ø=31.8 mm, and a dielectric block having no concave portion (hollow section) is used, favorable directivity can be achieved when the dielectric constant of the dielectric block is εr=2.3 (Comparison Example 1). However, when the dielectric constant is εr=4.1 (Comparison Example 2), the intensity difference between the main lobe and the side lobe is small, and favorable directivity cannot be achieved (see FIG. 4B and FIG. 4C).

However, in the dielectric loaded antenna 1, even when the dielectric constant of the dielectric block 20 is εr=4.1, favorable directivity can be achieved by the size of the hollow section formed by the concave portion 21 being adjusted accordingly (here, Th=10.9 mm and øh=12 mm). In addition, the width of the main lobe is widened (see FIG. 4A and FIG. 5B).

When the dielectric block without a concave portion is loaded onto the radiation patch 11, significant changes occur in frequency bands having little reflection (where favorable characteristics can be achieved). In the dielectric block having a concave portion, the change in frequency is suppressed (see FIG. 4A).

As described above, in the dielectric loaded antenna 1, directivity can be adjusted by the concave portion 21 being provided on the opposing bottom surface of the dielectric block 20 and the size of the hollow section formed by the concave portion 21 being adjusted.

Therefore, in the dielectric loaded antenna 1, the desired directivity in the desired frequency band can be obtained without the outer size of the dielectric block 20 (and, thus, the antenna opening size) being changed.

In addition, in the dielectric loaded antenna 1, the material (dielectric constant) of the dielectric block 20 can be selected as desired, regardless of the outer shape (size) of the dielectric block. Therefore, freedom of design can be enhanced.

In other words, in a conventional apparatus using a dielectric block having no concave portion 21, to achieve the desired directivity, the outer shape of the dielectric block is required to be adjusted after the design procedures (A), (B), and (C) are performed. However, when the outer shape of the dielectric block is adjusted, the outer size set at (B) and, thus, the opening size of the dielectric block antenna change. The directivity is affected in a manner differing from the effect intended by the adjustment of the outer shape. Therefore, it is very difficult to achieve a design in which the desired characteristics can be obtained.

In addition, in the dielectric loaded antenna 1, the concave portion 21 of the dielectric block 20 is formed to be of a size preventing the radiation patch 11 disposed within the hollow section formed by the concave portion 21 from coming into contact with the dielectric block 20.

### Second Embodiment

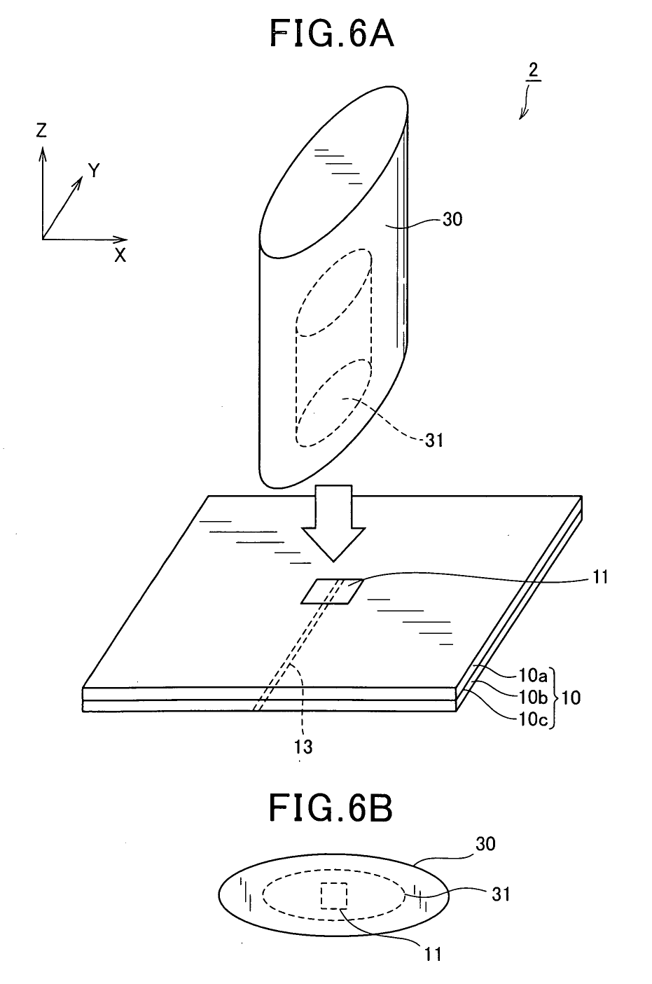

Next, a second embodiment of a dielectric loaded antenna according to the present invention will be described with reference to FIG. 6 to FIG. 8.

FIG. 6A is an exploded perspective view showing an overall configuration of a dielectric loaded antenna 2 according to the second embodiment and FIG. 6B is a top view showing the dielectric loaded antenna 2 of the FIG. 6A.

As shown in FIG. 6A and FIG. 6B, the dielectric loaded antenna 2 includes the substrate 10 configuring a patch antenna, and a dielectric block 30 disposed on the substrate 10 so as to cover a radio wave radiating area of the substrate 10.

The dielectric loaded antenna 2 differs from the dielectric loaded antenna 1 according to the first embodiment only with regard to the shape of the dielectric block 30. This difference will mainly be described, hereafter.

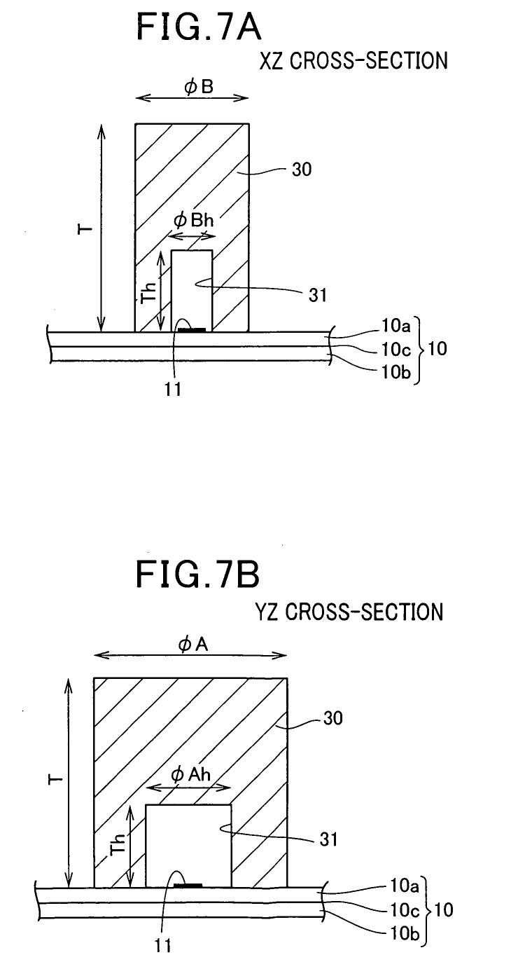

FIG. 7A is a cross-sectional view showing the dielectric loaded antenna 2 taken along an XZ plane passing through the center of the dielectric block 30 in FIG. 6. FIG. 7B is a cross-sectional view showing the dielectric loaded antenna 2 taken along an YZ plane passing through the center of the dielectric block 30 in FIG. 6.

As shown in FIG. 6A(B), FIG. 7A, and FIG. 7B, the dielectric block 30 is formed having an elliptical-cylindrical outer shape. The circular bottom surface of the dielectric block 30 is formed to be of a size covering the entire radiation patch 11. Hereinafter, of the pair of bottom surfaces of the elliptical-cylindrical dielectric block 30, the bottom surface on the side attached to the substrate 10 is referred to as an opposing bottom surface. The bottom surface on the other side is referred to as an opened bottom surface. In FIG. 7A and FIG. 7B, a direction along the minor diameter of the ellipse is an X axis. The direction along the major diameter of the ellipse is a Y axis.

A concave portion 31 forming a hollow section with the substrate 10 when the dielectric block 30 is attached to the substrate 10 is formed in the opposing bottom surface of the dielectric block 30.

The concave portion 31 is shaped such that an elliptical-cylindrical section concentric with the dielectric block 30 is carved out of the dielectric block 30. An inner diameter of the concave portion 31 is at least of a size preventing the radiation patch 11 disposed within the hollow section from coming into contact with the dielectric block 30.

The outer size (height T, major diameter øA, and minor diameter øB) of the dielectric block 30 and the size of the hollow section formed by the concave portion 31 (height Th, major diameter øAh, and minor diameter øBh) are set such that desired directivity can be achieved depending on a dielectric constant εr of the dielectric block 30.

A design procedure of the dielectric block 30 will be described as below.

Procedures (A) to (C) are performed in a manner similar to that according to the first embodiment.

In the procedure (A), the directivity half-power angle to be actualized is individually set for the X axis (major diameter) direction and the Y axis (minor diameter) direction. An opening size LA in the X axis direction and an opening size LB in the Y axis direction are calculated based on the set directivity half-powered angles. The major diameter øA is calculated from the opening size LA and the height T. The minor diameter øB is calculated from the opening size LB and the height T.

In the procedure (C), the major diameter øAh and the minor diameter øBh of the size of the hollow section are individually adjusted.

### <Test>

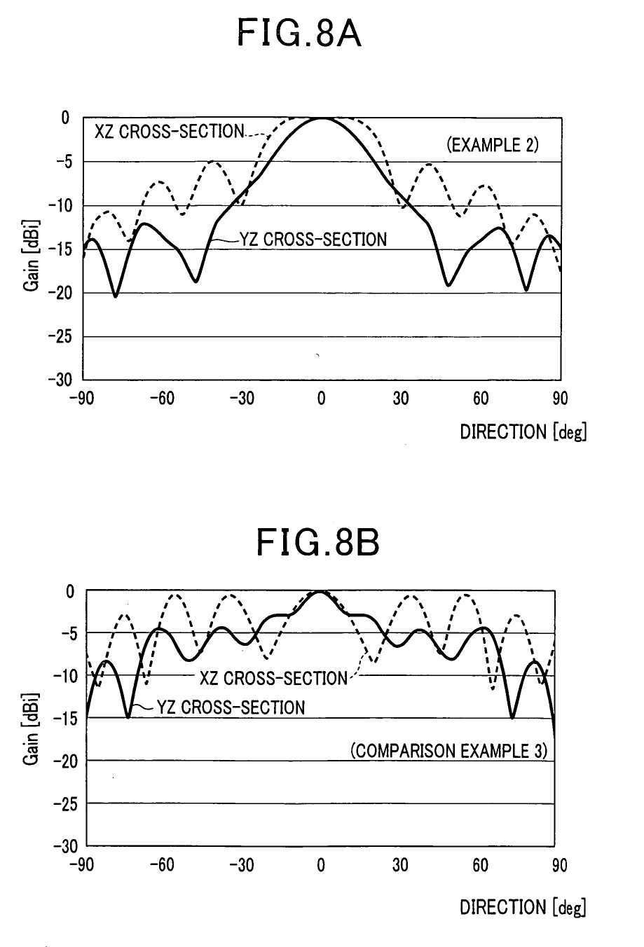

FIG. 8A and FIG. 8B show simulation results obtained by an electromagnetic field analysis simulator.

FIG. 8A shows results of the dielectric loaded antenna 2 of the present invention (referred to, hereinafter, as “Example 2”) in which directivity is adjusted by the concave portion 31 of the dielectric block 30. FIG. 8B shows results of a simple elliptical-cylindrical dielectric loaded antenna that does not have a concave portion 31 (referred to, hereinafter, as “Comparison Example 3”). A solid line indicates X axis (major diameter) direction characteristics. A dotted line indicates Y axis (minor diameter) direction characteristics.

The outer size of the dielectric block is T=36 mm, øA=31.8 mm, øB=19.1 mm in both the Example 2 and the Comparison Example 3. The dielectric constant of the dielectric block is εr=4.1 in both the Example 2 and the Comparison Example 3. The size of the hollow section of the dielectric block is Th=5 mm, øAh=23.8 mm, øBh=15.1 mm (only in the Example 2).

In the Comparison Example 3, favorable directivity cannot be obtained regarding both the directivity on the XZ plane and the directivity on the YZ plane because the intensity difference between the main lobe and the side lobe is small. On the other hand, in the Example 2, favorable directivity can be obtained regarding both the directivity on the XZ plane and the directivity on the YZ plane because the intensity difference between the main lobe and the side lobe is sufficiently large. In the Example 2, directivities can be achieved in which a difference in the width of the main lobe is ensured between the XZ plane and the YZ plane.

As described above, in the dielectric loaded antenna 2, directivity can be adjusted by the concave portion 31 being provided on the opposing bottom surface of the dielectric block 30 and the size of the hollow section formed by the concave portion 31 being adjusted. As a result, effects similar to those of the dielectric loaded antenna 1 according to the first embodiment can be achieved.

In addition, in the dielectric loaded antenna 2, because the outer shape of the dielectric block 30 and the shape of the hollow section formed by the concave portion 31 are elliptical-cylindrical, the directivity on the XZ plane and the directivity on the YZ plane can be individually designed. Freedom of design can be further enhanced.

### Other Embodiments

Embodiments of the present invention are described above. However, the present invention is not limited to the above-described embodiments. Various modifications can be made without departing from the scope of the present invention.

For example, according to the above-described embodiments, the outer shapes of the dielectric blocks 20 and 30 are cylindrical and elliptical-cylindrical. However, the outer shape can also be polygonal. Processing may be performed on the surfaces of the dielectric blocks 20 and 30 to adjust directivity, rather than the outer shapes of the dielectric blocks 20 and 30 being formed into simple shapes.

What is claimed is:

1. A dielectric loaded antenna, comprising:
a radiation source having a radiation surface from which radio waves are radiated; and
a dielectric block disposed such as to cover a radiation surface of the radiation source, wherein
the dielectric block has a cylindrical outer shape, in which an opposing bottom surface that is one bottom surface is disposed facing the radiation surface, and a concave portion used to adjust a phase of radio waves radiated via the dielectric block is formed in the opposing bottom surface.

2. The dielectric loaded antenna according to claim 1, wherein the concave portion is formed into a shape in which phases of radio waves radiated via the dielectric block match on a plane that comes into contact with the dielectric block at an opened bottom surface that is a bottom surface differing from the opposing bottom surface of the dielectric block and is perpendicular to an axial direction of the dielectric block.

3. The dielectric loaded antenna according to claim 1, wherein the concave portion is formed such that the dielectric block and the radiation surface of the radiation source are not in contact.

4. The dielectric loaded antenna according to claim 2, wherein the concave portion is formed such that the dielectric block and the radiation surface of the radiation source are not in contact.

5. The dielectric loaded antenna according to claim 1, wherein the outer shape of the dielectric block is cylindrical or elliptical-cylindrical.

6. The dielectric loaded antenna according to claim 2, wherein the outer shape of the dielectric block is cylindrical or elliptical-cylindrical.

7. The dielectric loaded antenna according to claim 3, wherein the outer shape of the dielectric block is cylindrical or elliptical-cylindrical.

8. The dielectric loaded antenna according to claim 4, wherein the outer shape of the dielectric block is cylindrical or elliptical-cylindrical.

9. A dielectric loaded antenna, comprising:
a radiation source having a radiation surface from which radio waves are radiated;
a dielectric block covering the radiation surface, having a cylindrical outer shape, a first bottom surface facing the radiation surface and a second bottom surface being configured as an opposite side of the first bottom surface; and
a concave block being formed at the first surface of the dielectric block so as to allow a phase of the radio waves radiating via the dielectric block to be adjusted.
